(19) United States
(12) Patent Application Publication
(10) Pub. No.: US 2025/0037594 A1
(43) Pub. Date: Jan. 30, 2025

(54) IMAGE PICKUP APPARATUS THAT ALLOWS PHOTOGRAPHER TO PRACTICE PORTRAIT PHOTOGRAPHING IN DESIRED ENVIRONMENT EVEN WITHOUT ACTUAL MODEL TO BE SUBJECT, AND THROUGH PRACTICE, IMPROVE KNOWLEDGE AND SKILLS IN PORTRAIT PHOTOGRAPHING, CONTROL METHOD, AND STORAGE MEDIUM

(71) Applicant: CANON KABUSHIKI KAISHA, Tokyo (JP)

(72) Inventor: Sota NAGAYOSHI, Tokyo (JP)

(21) Appl. No.: 18/777,623

(22) Filed: Jul. 19, 2024

(30) Foreign Application Priority Data
Jul. 28, 2023 (JP) 2023-123327

(51) Int. Cl. G09B 5/02; G06T 5/70; G06T 7/00; G06T 7/73; G06T 15/50; G06T 19/00; G10L 15/22; G10L 25/60; H04N 23/60; H04N 23/63

(52) U.S. Cl. CPC G09B 5/02; G06T 5/70; G06T 7/0002; G06T 7/75; G06T 15/50; G06T 19/006; G10L 15/22; G10L 25/60; H04N 23/632; H04N 23/64; G06T 2200/04; G06T 2207/30168; G06T 2207/30196

(57) ABSTRACT

An image pickup apparatus allowing a photographer to practice portrait photographing in a desired photographing environment is provided. The image pickup apparatus including a display unit that superimposes and displays an image of a virtual 3D avatar on a live view screen includes an obtaining unit to obtain first elements including information about a user and his/her surroundings, a setting unit to, in response to a user operation, set second elements including elements of the 3D avatar, which change in response to communication with the user, and elements of the 3D avatar, which do not change in response to the communication, an analyzing unit that performs analysis based on the first elements and the second elements, and a control unit that performs control so as to reflect a result of the analysis on the live view screen and the image of the 3D avatar superimposed and displayed thereon.

### BACKGROUND OF THE INVENTION

### Field of the Invention

The present invention relates to an image pickup apparatus, a control method, and a storage medium, and more particularly relates to an image pickup apparatus that supports a photographer to practice portrait photographing, a control method, and a storage medium.

### Description of the Related Art

Conventionally, photographing people (hereinafter, referred to as “portrait photographing”) using a camera has been performed. Furthermore, in recent years, as exemplified by a portrait mode on a smartphone, the portrait photographing itself has become common and popularized, and even a beginner photographer who does not have expensive equipment can easily perform the portrait photographing.

While it has become possible for a beginner photographer to easily perform the portrait photographing, advanced knowledge and skills are required to produce a high-quality portrait. For example, in a technique disclosed in Japanese Laid-Open Patent Publication (korai) No. 2005-217516, to support a photographer, a background image is projected onto a plain background member behind a subject to create an atmosphere suitable for photographing the subject, so that the photographer is able to draw out a desirable facial expression from the subject. However, the technique disclosed in Japanese Laid-Open Patent

Publication (kokai) No. 2005-217516 is merely intended to support the photographer when performing the portrait photographing of a person who is a model to actually be a subject. Therefore, it is the premise that the photographer has prepared a person to be the subject.

However, it is difficult for the photographer to arrange a person to be the model in a desired environment at any time for practicing the portrait photographing.

### SUMMARY OF THE INVENTION

The present invention provides an image pickup apparatus that allows a photographer to practice portrait photographing in a desired photographing environment even without an actual model to be a subject, and through the practice, improve knowledge and skills in the portrait photographing, a control method, and a storage medium.

Accordingly, the present invention provides an image pickup apparatus including a display unit that superimposes and displays an image of a virtual three-dimensional avatar on a live view screen, the image pickup apparatus comprising an obtaining unit configured to obtain first elements including information about a user and his/her surroundings, a setting unit configured to, in response to a user operation, set second elements including elements of the three-dimensional avatar, which change in response to communication with the user, and elements of the three-dimensional avatar, which do not change in response to the communication, at least one processor, and a memory coupled to the processor storing instructions that, when executed by the processor, cause the processor to function as an analyzing unit that performs analysis based on the first elements obtained by the obtaining unit and the second elements set by the setting unit, and a control unit that performs control so as to reflect a result of the analysis on the live view screen and the image of the three-dimensional avatar that is superimposed and displayed on the live view screen.

According to the present invention, it is possible for a photographer to practice portrait photographing in a desired photographing environment even without an actual model to be a subject, and through the practice, improve knowledge and skills in the portrait photographing.

Further features of the present invention will become apparent from the following description of exemplary embodiments with reference to the attached drawings.

### BRIEF DESCRIPTION OF THE DRAWINGS

FIG. 1 is a block diagram that shows a functional configuration of an image pickup apparatus according to a first embodiment.

FIG. 2 is a diagram for explaining an analyzing processing according to the first embodiment executed by the image pickup apparatus.

FIG. 3 is a flowchart of a photographing processing according to the first embodiment.

FIG. 4 is a diagram that shows an example of elements that affect a communication score according to the first embodiment.

FIG. 5 is a diagram that shows an example of a live view screen displayed on a display unit shown in FIG. 1 during the processing of steps S305 to S307 shown in FIG. 3.

FIG. 6A and FIG. 6B are diagrams that show examples of how an avatar appears on the live view screen when a depth of field and an in-focus distance are changed.

FIG. 7 is a diagram for explaining an analyzing processing according to a second embodiment executed by the image pickup apparatus.

FIGS. 8A, 8B, 8C, and 8D are conceptual diagrams that show a method for estimating ambient light based on a luminance distribution of a real object.

FIG. 9A and FIG. 9B are diagrams for explaining how an avatar appears when lighting by virtual light set in a step S701 shown in FIG. 7 is reflected on the avatar on the live view screen.

FIG. 10A and FIG. 10B are diagrams for explaining how an avatar appears when lighting by ambient light around a user estimated in a step S703 shown in FIG. 7 is reflected on the avatar on the live view screen.

FIG. 11 is a diagram that shows an example of joints that should not be cut off when performing portrait photographing.

FIG. 12 is a diagram for explaining an analyzing processing according to a third embodiment executed by the image pickup apparatus.

FIG. 13 is a diagram that shows an example of three-dimensional modeling of an avatar's wrist using a point cloud in computer graphics (CG).

FIG. 14 is a conceptual diagram that shows a position of the avatar's wrist shown in FIG. 13 in a virtual three-dimensional space and a photographing range during photographing performed by the image pickup apparatus associated with the virtual three-dimensional space.

FIG. 15 is a diagram that shows a flowchart of a joint cut-off determining processing according to the third embodiment.

FIG. 16A and FIG. 16B are diagrams for explaining the live view screens before and after a joint cut-off notification in a step S1506 shown in FIG. 15 is displayed.

FIG. 17 is a diagram for explaining an analyzing processing according to a fourth embodiment executed by the image pickup apparatus.

FIG. 18 is a diagram that shows an example of a relationship between an AI model that performs evaluation of a photographed image and its input parameters in the fourth embodiment.

FIG. 19 is a diagram that shows an example of evaluation information of a photographed image according to the fourth embodiment, which is generated by an analyzing unit and is displayed on the display unit.

FIG. 20 is a diagram that shows an example of comprehensive information of a plurality of photographed images according to the fourth embodiment, which is generated by an analyzing unit and is displayed on the display unit.

### DESCRIPTION OF THE EMBODIMENTS

The present invention will now be described in detail below with reference to the accompanying drawings showing embodiments thereof.

Hereinafter, preferred embodiments of the present invention will be described with reference to the drawings, but the present invention is not limited to the embodiments described below.

In an image pickup apparatus according to the present invention, when a user starts practicing portrait photographing, a virtual three-dimensional avatar (hereinafter, referred to as “an avatar”) is displayed on a live view screen of a display unit. In other words, the image pickup apparatus according to the present invention provides the user with a virtual reality (VR) or augmented reality (AR) experience, as if the avatar displayed on the display unit is present around the user.

### (First Embodiment) (Communication Evaluation Value)

### <Functional Configuration of Image Pickup Apparatus>

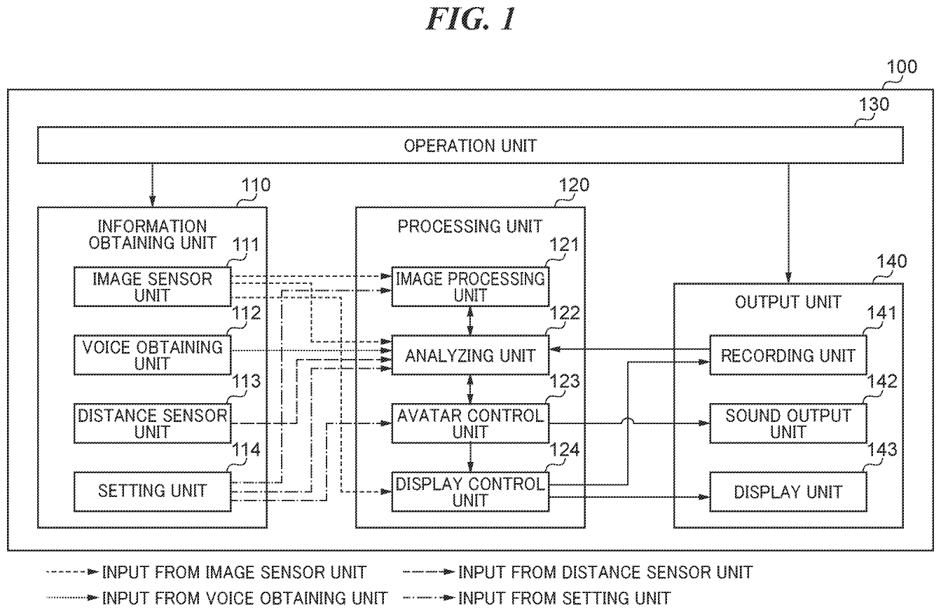

First, a functional configuration of an image pickup apparatus 100 according to the first embodiment will be described with reference to a block diagram of FIG. 1.

As shown in FIG. 1, the image pickup apparatus 100 includes an information obtaining unit 110 that mainly obtains predetermined information, a processing unit 120 that performs predetermined processing within the image pickup apparatus 100, an operation unit 130 that is used to operate the image pickup apparatus 100, and an output unit 140 that outputs the predetermined information.

The operation unit 130 is used by the user to perform settings related to photographing and other necessary settings and to input data. For example, the operation unit 130 includes a cross key, a stick, buttons, a touch panel type display, and a microphone.

The information obtaining unit 110 includes an image sensor unit 111, a voice obtaining unit 112, a distance sensor unit 113, and a setting unit 114.

The image sensor unit 111 is an image pickup device configured with a CCD image sensor or a CMOS image sensor that converts an optical image into electrical signals (a photographed image).

The voice obtaining unit 112 is a microphone that obtains voice uttered by the user as conversation information. The image pickup apparatus 100 may accept operations by voice, in which case the operation unit 130 performs voice input.

The distance sensor unit 113 is a sensor capable of measuring a distance from the image pickup apparatus 100 to an arbitrary object and obtaining the distance as distance information. Examples of this sensor include a RGB camera, an infrared camera, a stereo camera, a light detection and ranging sensor (an LiDAR sensor), and a millimeter wave sensor. It should be noted that the distance from the image pickup apparatus 100 to an arbitrary object can also be measured by using an image sensor, in which case the image sensor unit 111 may function as the distance sensor unit 113.

The setting unit 114 performs settings of predetermined parameters with respect to the image pickup apparatus 100. The predetermined parameters include a F-number (an aperture value or a depth of field), an ISO sensitivity, a shutter speed, a white balance, a focal length, etc., and also include parameters of the avatar. The parameters of the avatar include, for example, an age, a gender, an appearance, a personality, a facial expression, a pose, a position, etc. It should be noted that the settings with respect to the setting unit 114 are inputted by operating the operation unit 130. Settings on the avatar will be described in detail below.

The processing unit 120 includes an image processing unit 121, an analyzing unit 122, an avatar control unit 123, and a display control unit 124. The processing unit 120 is configured with a central processing unit (a CPU), a micro processing unit (an MPU), a graphics processing unit (a GPU), or the like.

The image processing unit 121 performs various kinds of image processing with respect to the photographed image inputted from the image sensor unit 111 in accordance with the parameters set by the setting unit 114.

The analyzing unit 122 performs analysis based on the conversation information obtained by the voice obtaining unit 112, the distance information obtained by the distance sensor unit 113, and the parameters set by the setting unit 114.

The avatar control unit 123 generates an image and a voice of the avatar based on the parameters of the avatar that are set by the setting unit 114, and controls the behavior of the avatar. For example, in the case that the avatar is set to have a bright and lively personality, control of the output unit 140 is performed so that the avatar becomes spontaneously speaking (talking) a lot, and expressive. In addition, a spoken voice of the avatar by this control is integrated with the voice of the user obtained by the voice obtaining unit 112, and is used as the conversation information to be analyzed by the analyzing unit 122.

The display control unit 124 integrates the photographed image from the image sensor unit 111, the image processing performed with respect to the photographed image by the image processing unit 121, an analysis result obtained by the analyzing unit 122, and the behavior of the avatar controlled by the avatar control unit 123. Thereafter, the display control unit 124 outputs the integrated result to a recording unit 141 (described below) and a display unit 143 (described below) of the output unit 140.

The output unit 140 includes the recording unit 141, a sound output unit 142, and the display unit 143.

The recording unit 141 is configured with a recording medium, and performs recording of the photographed image inputted from the image sensor unit 111. Examples of the recording medium that can be used include an optical disk, a magnetic disk, a hard disk, and a memory. At this time, the image and the voice of the avatar are also recorded.

The sound output unit 142 outputs the spoken voice of the avatar controlled by the avatar control unit 123. The sound output unit 142 is configured by, for example, a speaker or a headphone.

The display unit 143 displays a user operation screen, the photographed image, setting information, the avatar, analysis information, etc. The display unit 143 is configured by, for example, a liquid crystal display or an organic electroluminescence display (an organic EL display). In addition, the display unit 143 may perform display, and accept touch operations at the same time, in which case the display unit 143 is included in a part of the operation unit 130.

### <Overview of Photographing System>

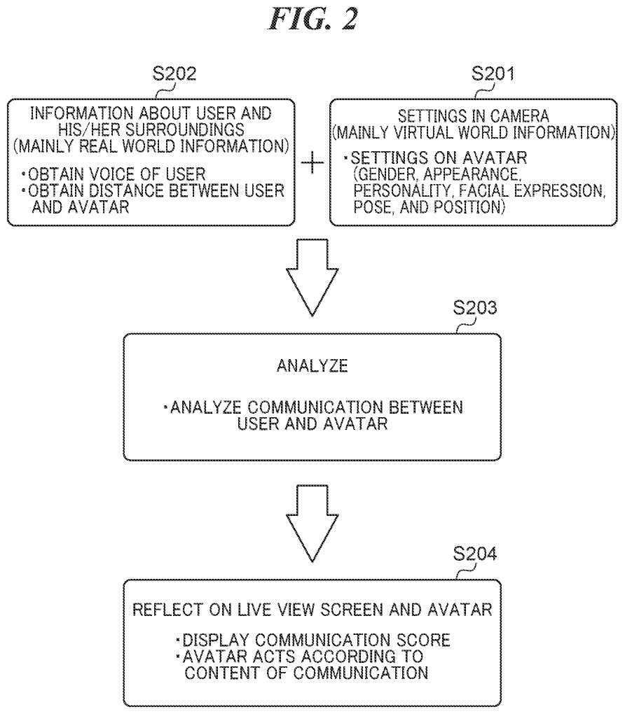

Next, an analyzing processing according to the first embodiment executed by the image pickup apparatus 100 will be described with reference to FIG. 2.

As shown in FIG. 2, in a step S201, the setting unit 114 (a setting unit) performs settings in the image pickup apparatus 100. In this step, mainly virtual world information such as the appearance and the pose of the avatar is obtained.

In a step S202, information about the user and his/her surroundings is obtained by the image sensor unit 111, the voice obtaining unit 112, and the distance sensor unit 113 that function as an obtaining unit. In this step, mainly real world information such as the voice of the user and a distance between the user and the avatar is obtained.

In a step S203, the analyzing unit 122 (an analyzing unit) analyzes the communication between the user and the avatar based on the information obtained in the step S201 and the information obtained in the step S202, and generates analysis information.

In a step S204, the avatar control unit 123 and the display control unit 124 that function as a control unit control the display unit 143 and the sound output unit 142 so as to reflect the content of the analysis information generated in the step S203 on the live view screen and the avatar superimposed and displayed on the live view screen.

The respective steps will be described in detail below.

First, the details of the step S201 will be described.

In the step S201, the setting unit 114 performs the settings on the age, the appearance, the personality, the facial expression, the pose, the position, and so on of the avatar in response to a user operation on the operation unit 130. The avatar is generated by the avatar control unit 123 based on the information about the avatar that has been set, and the avatar behaves autonomously according to the settings. “Autonomous behavior according to the settings” refers to the avatar's actions, such as becoming spontaneously speaking (talking) a lot and expressive in the case that the avatar is set to have a bright and lively personality.

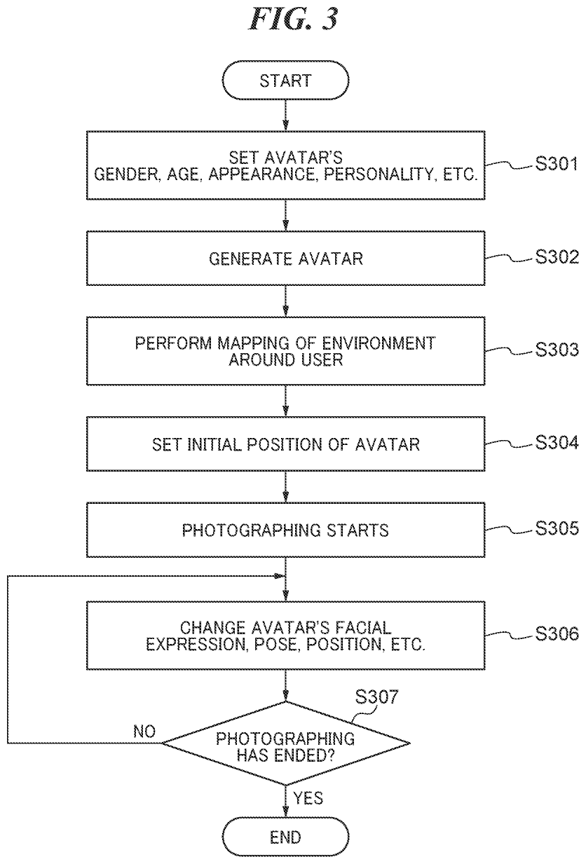

Here, a photographing processing according to the first embodiment, in which the avatar is superimposed and displayed on the live view screen and is photographed, will be described with reference to a flowchart of FIG. 3.

As shown in FIG. 3, first, the parameters such as the gender, the age, the appearance, the personality and so on of the avatar are set by the setting unit 114 in response to a user operation on the operation unit 130 (a step S301). At this time, the facial expression and the pose of the avatar that have been preset are also read out.

Next, the avatar control unit 123 generates the avatar based on the parameters of the avatar that have been set in the step S301 (a step S302).

Next, in order to superimpose the avatar generated in the step S302 onto the real world, the distance sensor unit 113 and the analyzing unit 122 perform mapping of an environment around the user (a step S303). At this time, for example, a simultaneous localization and mapping technique (an SLAM technique) is used for the mapping. Since the SLAM technique is publicly known, a description thereof will be omitted.

Next, an initial position of the avatar is set according to the result of the mapping of the environment around the user obtained in the step S303 and a selection operation performed by the user on the operation unit 130, which selects the position of the avatar on the display unit 143 (a step S304).

Through the above steps, the initial setting of the avatar is completed, and photographing starts in a state in which the avatar has been superimposed on the display unit 143 (a step S305). During the photographing, the avatar is controlled so as to behave autonomously according to the parameters that have been set in the step S301. The control of the avatar is performed by the avatar control unit 123.

During the photographing, the facial expression, the pose, and the position of the avatar are changed in response to a user instruction. This user instruction is issued by operating the operation unit 130 or by the user's voice operation (a step S306). The user's voice operation will be described below.

Next, the analyzing unit 122 determines whether or not the photographing has been completed (a step S307). For example, the analyzing unit 122 determines whether or not the user has performed an operation to end the photographing by using the operation unit 130. At this time, in the case that the operation to end the photographing has not been performed (NO in the step S307), the photographing processing shifts to the step S306, and the photographing is continued. On the other hand, in the case that the operation to end the photographing has been performed (YES in the step S307), the photographed image (a portrait image in which the avatar is superimposed and displayed on a real object) is recorded in the recording unit 141, and the photographing processing ends.

Next, the details of the step S202 will be described.

In the step S202, the voice obtaining unit 112 (the obtaining unit) obtains the voice of the user, and the distance sensor unit 113 (the obtaining unit) obtains the distance between the user and the avatar (for example, obtains three-dimensional information by using an LiDAR sensor). It should be noted that when the photographing starts in the step S305, the user is able to have interactive communication through a conversation with the avatar displayed on the display unit 143. Here, the concept of “the conversation” includes voice exchanging (voice interactions) between the user and the avatar, and silences (silent parts) between the user and the avatar. In addition, “the interactive communication” includes, for example, communication such as the avatar becoming embarrassed expression when the user compliments the avatar, and the avatar posing in accordance with an instruction from the user.

Next, the details of the step S203 and the step S204 will be described.

In the step S203, the analyzing unit 122 analyzes the information about the user and the avatar obtained in the step S201 and the step S202.

In addition, in the step S204, the content of the analysis information obtained in the step S203 is outputted to the display unit 143 and the sound output unit 142 so as to be reflected on the live view screen and the avatar.

Since the step S203 and the step S204 affect each other, they will be described together.

The items to be analyzed in the step S203 are not particularly limited as long as they are information about the voice extracted from the information about the user and the avatar. For example, examples of the items to be analyzed in the step S203 include what and how much the user speaks (talks) to the avatar, a frequency of silence of the user, a volume of the voice of the user, and a speed at which the user speaks (talks), the number of times speaking of the user overlaps with speaking of the avatar in the conversation, and a ratio of a speaking time of the user to a speaking time of the avatar (a talk-to-listen ratio).

In the step S204, in the case that the analysis, which indicates that the user has given the avatar “an instruction regarding the facial expression, the pose, the position, or the like”, has been performed, that information is transmitted to the avatar control unit 123, and the avatar control unit 123 performs control in accordance with the content of that information. For example, in the case that the content of that information is “raise your hands”, the avatar control unit 123 controls the avatar to raise its hands, and the avatar with its hands raised is displayed on the display unit 143 via the display control unit 124.

In addition, even in the case that the content of that information is not the instruction regarding the facial expression, the pose, the position, or the like, the facial expression, the pose, and the position of the avatar may be affected based on what the user has spoken. For example, in the case that the analysis, which indicates that the user “has complimented” the avatar, has been performed, the avatar control unit 123 controls the avatar to make its facial expression to show a smile. This enables more natural communication between the user and the avatar.

Furthermore, in the step S203, in addition to the analysis of the voice described above, the analyzing unit 122 also takes into account the settings on the avatar, the distance between the user and the avatar obtained by the distance sensor unit 113, etc., and then analyzes the quality (the qualitative goodness) of the communication between the user and the avatar. The result of this analysis is quantified and is calculated as a communication score.

The settings on the avatar may affect the communication score. For example, in the case that the avatar is set to have a quiet personality, the communication score will decrease if the user talks (speaks) too much to the avatar. In addition, in the case that the age of the avatar is set low (that is, in the case that the avatar is set to be a child), the communication score will increase if the user talks (speaks) slowly and in simple language to the avatar.

In addition, the distance between the user and the avatar may affect the communication score. For example, the communication score will decrease if the user gets too close to the avatar.

The calculated communication score is outputted and displayed on the display unit 143 in the step S204. This allows the user to monitor the communication score in real time and provide immediate feedback on how he/she is communicating with his/her avatar. For example, in the case that the communication score decreases due to a period of silence, it is possible to improve the communication by, for example, talking more.

In addition, the communication score itself may also be used as one index when calculating the communication score, and further, the communication score may be reflected in the behavior of the avatar. For example, in the case that the communication score is low, the analyzing unit 122 further lowers the communication score when the user approaches the avatar. In this case, the avatar control unit 123 controls the avatar to have a troubled expression. On the other hand, in the case that the communication score is high, the analyzing unit 122 maintains the communication score without lowering the communication score even if the user approaches the avatar. In this case, the avatar control unit 123 controls the facial expression of the avatar so as to maintain a smile.

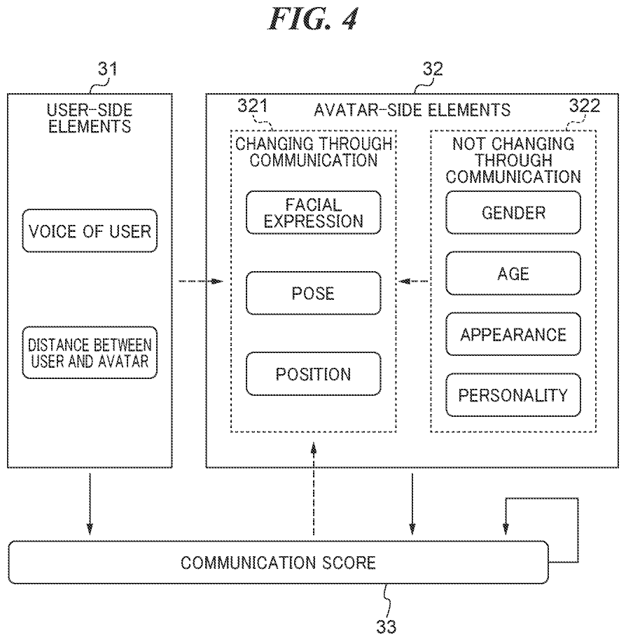

Here, how each of the elements described above that affect the communication score affects each other will be described with reference to FIG. 4.

As shown in FIG. 4, the elements that affect the communication mainly include user-side elements 31, avatar-side elements 32, and a communication score 33.

The user-side elements 31 (first elements) are the elements that have been obtained in the step S202 and have been described with reference to FIG. 2.

The avatar-side elements 32 (second elements) are the elements that have been obtained in the step S201 and have been described with reference to FIG. 2. It is possible to divide the avatar-side elements 32 into “unchanging elements 322” and “changing elements 321” through the communication between the user and the avatar. For example, the facial expression of the avatar changes depending on the communication with the user and is therefore “the changing element 321”, whereas the age of the avatar is “the unchanging element 322” that does not change during the communication with the user.

Furthermore, the elements that affect the change in the communication score other than the user-side elements 31 are the communication score 33 itself, and “the changing elements 321” among the avatar-side elements 32 that change depending on the communication.

As indicated by dashed arrows shown in FIG. 4, “the changing elements 321”, which change depending on the communication, change under the influence of the user-side elements 31, “the unchanging elements 322” that do not change during the communication, and the communication score 33.

In addition, as indicated by solid arrows shown in FIG. 4, the communication score 33 changes under the influence of the user-side elements 31, the avatar-side elements 32, and the communication score 33 itself.

It should be noted that the elements that affect the communication score are not limited to the elements shown in FIG. 4 that have been described above, and in the case that there are elements that the user needs to take into consideration when communicating with the avatar, they can be added as appropriate and combined with other elements.

As the method for calculating the communication score, for example, a calculation method using artificial intelligence (AI) can be used.

An AI model used in this calculation method is trained, for example, as follows.

First, a voice of a professional photographer and a distance from the professional photographer to an actual model (also simply referred to as “a model”), which are obtained when the professional photographer is performing the portrait photographing of the actual model, are obtained as parameters in time series. In addition, a gender, an age, an appearance, and a personality of the model, as well as changes in time series in a facial expression, a pose, and a position of the model during the portrait photographing, are also obtained as parameters. In addition, a communication score during the portrait photographing is always set to 100 points, and this is also obtained as a parameter.

Next, by inputting the various obtained parameters, the AI model is trained so that an output value (the communication score) becomes 100 points. By conducting this type of learning (training) with a variety of professional photographers and a variety of situations, it is possible to create the AI model that the communication score of the way the professional photographer communicates when performing the portrait photographing is set to 100 points.

At this time, it is possible to further enhance the accuracy by also training the AI model with portrait photographing data obtained from photographers other than the professional photographers. For example, when an amateur photographer has performed the portrait photographing of an actual model, it is possible to obtain various parameters including parameters that result in a communication score of 70 points, and the AI model may be additionally trained so that when the various obtained parameters are inputted, the output value will be 70 points. Similarly, for portrait photographing performed by a person who has never performed photographing with a camera other than a smartphone, the AI model may be additionally trained so that the communication score, which is the input parameter, and the output value are both 30 points.

Furthermore, the AI model may be additionally trained by changing the communication score, which is the input parameter, and the output value after taking into account the elements that affect communication skills of the photographer. For example, in the case that the photographer has owned a camera for a long time, or in the case that the photographer has photographed a large number of images (that is, there are a large number of photographed images so far), since the communication skills are likely to be higher, the communication score, which is the input parameter, and the output value are set higher.

As a result, it is possible to create the AI model that has been trained so that the better (higher) the communication skills of the person (the photographer) in the portrait photographing, the higher the output value. This AI model is created in advance and is loaded into (installed in) the analyzing unit 122. As a result, it is possible to output the communication score after update (the updated communication score) by inputting the user-side elements 31, the avatar-side elements 32, and the communication score 33 before update that have been obtained during photographing with the image pickup apparatus 100 into the AI model.

As described above, in the image pickup apparatus 100 according to the first embodiment, the analysis information on a plurality of elements is reflected in the behavior of the avatar (the changing elements 321) and the communication score. As a result, the user is able to practice the communication during the portrait photographing without having to prepare a subject (a model to be photographed).

### <Screen Display>

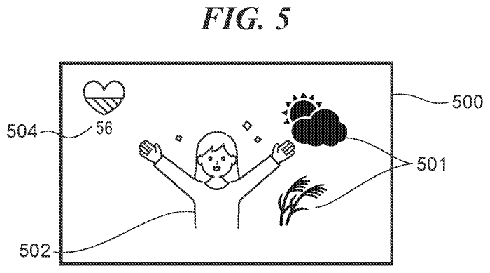

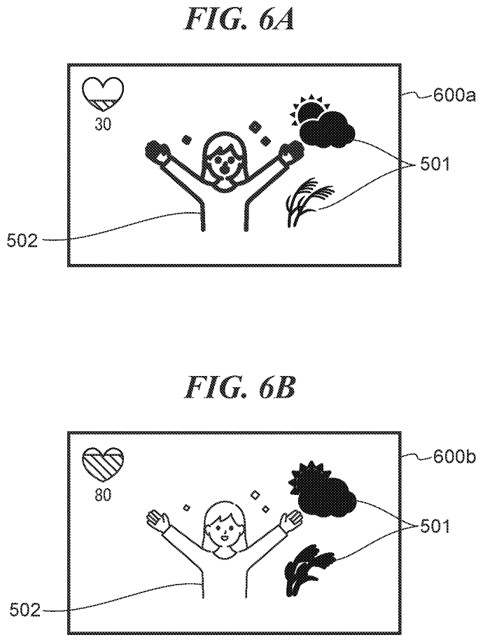

Next, a live view screen according to the first embodiment, which is displayed on the display unit 143 during the processing of the steps S305 to S307 shown in FIG. 3, will be described with reference to FIG. 5, FIG. 6A, and FIG. 6B. FIG. 5 is a diagram that shows an example of this live view screen. FIG. 6A and FIG. 6B are diagrams that show examples of how the avatar appears on the live view screen when the depth of field and an in-focus distance are changed.

An image of real objects 501 such as a real-world landscape and an object, which has been picked up by the image sensor unit 111 is outputted to a live view screen 500 exemplified in FIG. 5.

In addition, under the control of the display control unit 124, a virtual avatar 502 (hereinafter, simply referred to as “an avatar 502”) set by the setting unit 114 is superimposed and displayed on the real objects 501. At this time, since the position of the avatar 502 in the real world has been determined by the setting unit 114 and the avatar control unit 123, the avatar 502 is superimposed and displayed on the real objects 501 only when the avatar 502 is included within an angle of view of the image pickup apparatus 100. Furthermore, since the distance between the user (the image pickup apparatus 100) and the avatar 502 has also been obtained by the distance sensor unit 113, the analyzing unit 122 is able to determine a distance relationship in a depth direction between the real objects 501 and the avatar 502. Therefore, in the case that the avatar 502 is positioned in front of the real objects 501 under the control of the display control unit 124, the avatar is displayed on the live view screen 500 (the real objects 501 are hidden by the avatar 502). On the other hand, in the case that the avatar 502 is positioned behind the real objects 501 under the control of the display control unit 124, the real objects 501 are displayed on the live view screen 500 (the avatar 502 is hidden by the real objects 501).

Furthermore, a communication score 504 calculated by the analyzing unit 122 is also superimposed and displayed on the live view screen 500. At this time, the communication score may be displayed directly as a numerical value, or may be displayed as a graphical representation (for example, as shown in FIG. 5, a graphical representation indicating how much of a heart mark is filled by a shaded area) in consideration of visual ease, or may be displayed as a combination of a numerical value and a graphical representation. It should be noted that in a state where it is not possible to calculate the communication score before the communication between the user and the avatar 502 starts, an appropriate initial value (for example, 50) is set and is displayed on the live view screen 500.

In a live view screen 600a exemplified in FIG. 6A and a live view screen 600b exemplified in FIG. 6B, the F-number is changed by the setting unit 114, and the depth of field is made shallower than that of the live view screen 500. Furthermore, the live view screen 600a shown in FIG. 6A is a live view screen when focusing on the real objects 501 that are a distant view, and the live view screen 600b shown in FIG. 6B is a live view screen when focusing on the avatar 502 that is a close-range view.

Generally, in the case that the depth of field is shallow, a blurring level (an amount of blurring) increases as a distance from an in-focus position (a focused position) increases. That is, in the case of focusing on the distant view as in FIG. 6A, the distant real objects 501 (the landscape, the object, etc.) should be displayed sharply, while nearby real objects should be displayed very blurred. However, since the avatar 502 is not a real object but a virtual object generated within the image pickup apparatus 100, the avatar 502 is not optically affected by a lens. Therefore, on the live view screen 600a, the image processing unit 121 performs a blurring processing with respect to the avatar 502. As a result, it is possible to display the avatar 502 on the live view screen 600a in such a way that it appears as if the avatar 502 is a real object.

At this time, the amount of blurring that is applied to the avatar 502 during the blurring processing is controlled according to the distance from the in-focus position to the position of the avatar 502 in the real world. That is, for example, the closer the distance from the in-focus position (the focused position) to the avatar 502, the smaller the amount of blurring that is applied to the avatar 502 during the blurring processing, thereby making the avatar 502 appear closer to how it actually appears.

In addition, in the case of focusing on a desired real object, a manual focus operation (an MF operation) or an autofocus operation (an AF operation) can be considered. However, since the avatar 502 is not a real object but a virtual object, it is not possible to focus on the avatar 502 by using the AF operation. On the other hand, the image pickup apparatus 100 includes the distance sensor unit 113 that obtains the distance between the user and the avatar 502. Therefore, in the case that the AF operation has been performed with respect to the position where the avatar 502 is present on the live view screen 600a (the position of the avatar 502 in the real world), the focus adjustment in the image pickup apparatus 100 is automatically performed according to the distance obtained by the distance sensor unit 113. That is, in this case, as shown in the live view screen 600b shown in FIG. 6B, the image processing unit 121 does not perform the blurring processing with respect to the avatar 502, and the avatar 502 is displayed in such a way that it appears to be in focus. On the other hand, the real objects 501, which are the distant view, is optically affected by the lens and thus is displayed blurred. As described above, the blurring processing is performed with respect to the avatar, which is a virtual object superimposed and displayed on the live view screen, according to the distance from the in-focus position, and the AF operation becomes possible on the avatar, which is a virtual object. As a result, the user becomes able to practice the portrait photographing making use of blurring.

As described above, according to the first embodiment, the user is able to practice the portrait photographing including communicating with the subject without having to prepare a subject (a model to be photographed).

### (Second Embodiment) (Reflecting Real Light and Virtual Light on Avatar)

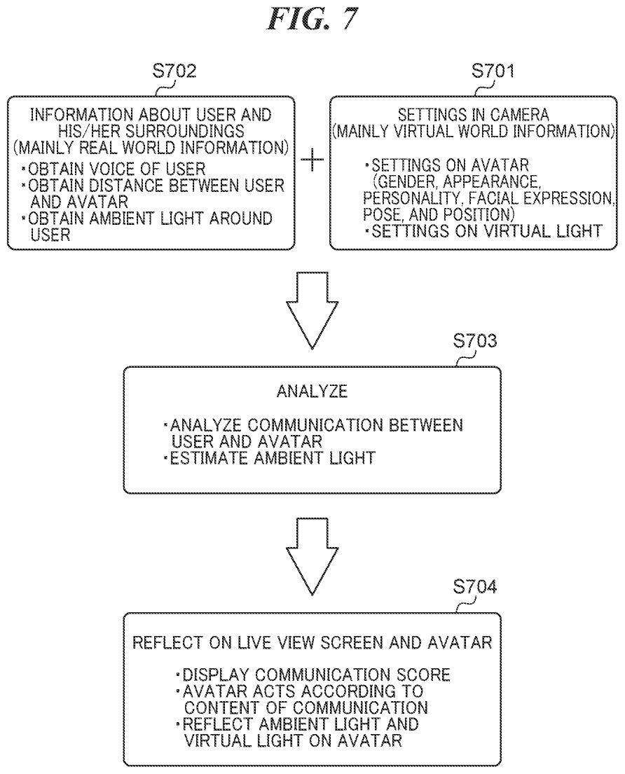

Hereinafter, an image pickup apparatus 100 according to the second embodiment will be described with reference to FIGS. 7 to 10B. The second embodiment is characterized in that ambient light around the user and virtual light set by the user are reflected in the lighting to the avatar on the live view screen. It should be noted that in the second embodiment, descriptions of parts that overlap with the first embodiment will be omitted.

First, an analyzing processing according to the second embodiment executed by the image pickup apparatus 100 will be described with reference to FIG. 7.

As shown in FIG. 7, in a step S701, the same settings as in the step S201 are performed, and the user is also able to set at least one or more of a type, an amount of light, a color, and a position of a virtual light source, as well as the number of virtual light sources by the setting unit 114 via the operation unit 130. For example, in the case that the color of the virtual light source is set to “the sun light that has a warm color”, the color of the ambient light reflected on the avatar is changed to a warm color. In addition, in the case that the type of the virtual light source is a strobe light, as a position of the strobe light and the number of strobe lights, it is possible to set to, for example, “two white strobe lights diagonally behind the subject”, “white strobe light from the camera reflected off the ceiling”, or “one light reflected from a strobe light shade”. Here, “the virtual light source” refers to a light source that does not exist in reality (around the user) and is virtually installed within the image pickup apparatus 100, and the state of the lighting to the avatar changes depending on the settings of the virtual light source. In addition, in order to perform the settings easier, modes of “the virtual light source” such as “a back lighting mode”, “a front lighting mode”, and “a side lighting mode” may be provided, and the user may be allowed to select one of them. For example, in the case that “the back lighting mode” has been selected, the lighting that the sun light is shining on the avatar from behind is automatically set. In other words, even in the case that the actual ambient light is front lighting, the lighting reflected on the avatar appears as if it is back lighting. In addition, in the case that the user does not perform the settings of the virtual light source, the lighting from the actual ambient light is reflected on the avatar. On the other hand, in the case that the type of the virtual light source is a strobe light, the lighting, which is from both the virtual light source and the actual ambient light, is reflected on the avatar.

In a step S704, in the case that the virtual light has been set by the user in the step S701, based on information on the set virtual light, the image processing unit 121 performs a lighting processing that performs virtual lighting with respect to the avatar. Thereafter, the display control unit 124 performs control so that the image of the avatar after the lighting processing is superimposed and displayed on the live view screen on the display unit 143.

It is possible to realize setting of the virtual light and the lighting processing, for example, by using a 3D graphics function. The 3D graphics function is able to place virtual object(s) and light source(s) in a virtual space within a computer and simulate their effects through calculations. In addition, it is possible to select the type, the amount of light, the color, the position, the number, etc. of the light source of the virtual light (hereinafter, referred to as “the virtual light source”).

Since the image processing unit 121 includes the above-mentioned 3D graphics function, by importing the avatar generated by the avatar control unit 123, it is possible to calculate the virtual lighting with respect to the avatar. Here, the user selects the virtual light source as well as the type, the amount of light, the color, the position, the number, etc. of the virtual light source through the operation unit 130.

In addition, in the image pickup apparatus 100 according to the second embodiment, the image sensor unit 111 obtains the ambient light around the user (a step S702), and the analyzing unit 122 estimates the ambient light (a step S703). Here, the items to be estimated are at least one of a type, an amount of light, a color, a position of the light source of the ambient light (hereinafter, referred to as “a real light source”), and the number of real light sources.

A representative method for estimating the ambient light is, for example, a method of estimating the ambient light based on a luminance distribution formed on the surface of the real object.

In the method of estimating the ambient light based on the luminance distribution formed on the surface of the real object, by obtaining a normal line and luminance of the real object from the image photographed by the image pickup apparatus 100, it is possible to estimate a strength, a direction (the position), the type of the real light source, and the number of the real light sources. Here, in order to obtain the normal line of the real object, the shape of the real object needs to have been already known, but in the second embodiment, the shape of the real object has been obtained by the distance sensor unit 113 when performing the mapping of the environment around the user in the step S303.

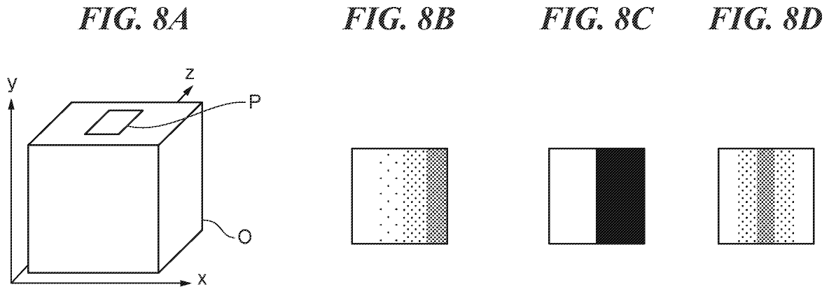

The method of estimating the ambient light based on the luminance distribution of the real object will be described in more detail with reference to FIGS. 8A, 8B, 8C, and 8D. Here, as an example, a luminance distribution of a specific region P of a cubic real object O shown in FIG. 8A is observed. FIGS. 8B, 8C, and 8D are diagrams that show examples of the luminance distribution of the specific region P when the real object O is viewed from the +y direction.

For example, in the case that the specific region P has a luminance distribution shown in FIG. 8B, it is possible to estimate that weak diffused light from the −x direction is being irradiated as the ambient light. In addition, in the case that the specific region P has a luminance distribution shown in FIG. 8C, it is possible to estimate that strong linear light is being irradiated from the +y direction onto only the left half. Furthermore, in the case that the specific region P has a luminance distribution shown in FIG. 8D, it is possible to estimate that there are two weak diffused lights aligned in the −x direction and the +x direction. It should be noted that in the case that the image sensor unit 111 is an RGB sensor, since it is possible to obtain the luminance value of each of RGB, it is also possible to estimate the color of the light.

For simplicity of the description, the estimation of the ambient light irradiated on one specific region has been described, but the accuracy of the estimation can be improved by using a plurality of regions for the estimation.

Furthermore, in addition to the above-mentioned method, there are many other publicly-known methods for estimating the ambient light such as a method for estimating the ambient light based on a shadow formed by the real object. Since these methods are publicly-known methods, detailed descriptions thereof will be omitted, but the method for estimating the ambient light used in the second embodiment may be any one of the publicly-known methods, or may be a combination of the publicly-known methods, as long as it is capable of estimating at least one or more of the type, the amount of light, the color, and the position of the real light source, as well as the number of the real light sources.

In the case that the type of the virtual light source is set to a strobe light in the step S701 or in the case that no virtual light source is set in the step S701, the ambient light is estimated in the step S703, the virtual light source that coincides with the real light source is set by the image processing unit 121, and the lighting processing is performed (the step S704). The process leading up to reflecting the virtual light source on the avatar has already been described, so it will be omitted here.

Reflecting the actual ambient light around the user on the avatar and reflecting the virtual light set by the user on the avatar have been described, respectively, but these can also be used in combination. For example, by going outside at night in real life and setting a strobe light as the virtual light source to perform the lighting to the avatar, it is possible to practice “night-time portrait photographing making use of a strobe light” without having to carry around equipment and the like.

### <Screen Display>

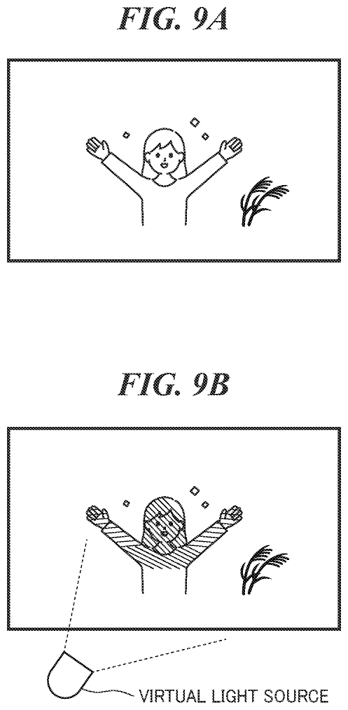

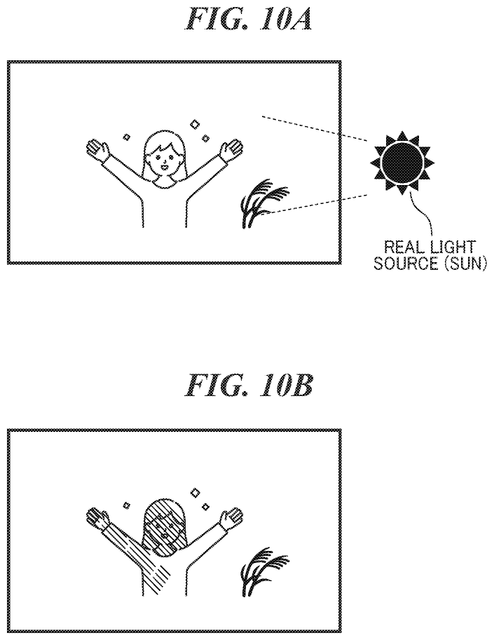

Next, a live view screen according to the second embodiment, which is displayed on the display unit 143 during the processing of the steps S305 to S307 shown in FIG. 3, will be described with reference to FIG. 9A, FIG. 9B, FIG. 10A, and FIG. 10B. FIG. 9A and FIG. 9B are diagrams for explaining how an avatar appears when the lighting by the virtual light set in the step S701 shown in FIG. 7 is reflected on the avatar on the live view screen. FIG. 10A and FIG. 10B are diagrams for explaining how an avatar appears when the lighting by the ambient light around the user estimated in the step S703 shown in FIG. 7 is reflected on the avatar on the live view screen.

FIG. 9A is an example of the live view screen in the case that no lighting processing is performed on the avatar as in the first embodiment, and FIG. 9B is an example of the live view screen after the lighting from the virtual light set in the step S701 has been reflected on the avatar.

As shown in FIG. 9A, in the case that no lighting processing is performed on the avatar, the avatar is displayed uniformly bright on the live view screen. On the other hand, when the virtual light source (one white strobe light) is set in front of the avatar, as shown in FIG. 9B, the live view screen, in which the lighting from the virtual light has created a shadow on the front of the avatar (the face of the avatar has become in shadow), is displayed.

FIG. 10A is an example of the live view screen in the case that no lighting processing is performed on the avatar as in the first embodiment, and FIG. 10B is an example of the live view screen after the lighting from the ambient light estimated in the step S703 has been reflected on the avatar.

As shown in FIG. 10A, in the case that no lighting processing is performed on the avatar, the avatar is displayed uniformly bright on the live view screen even in the case that there is a real light source (the sun) on the left side of the avatar. On the other hand, when the virtual light source that coincides with the real light source is set by estimating the ambient light, as shown in FIG. 10B, the live view screen, which has been corrected so that the left side of the avatar is bright, the right side of the avatar is dark, and the face of the avatar is in shadow, is obtained.

As described above, in the second embodiment, the lighting, which has reflected the actual ambient light around the user and the virtual light set by the user, is performed with respect to the avatar on the live view screen. As a result, the user will be able to perform the portrait photographing that takes into account the influence of the light source, improving his/her knowledge and skills in photographing making use of the light source. In addition, since there is no need to prepare the equipment, the environment, and the like, even a beginner photographer is able to easily practice.

### (Third Embodiment) (Detection of Joint Cut-Off Photo)

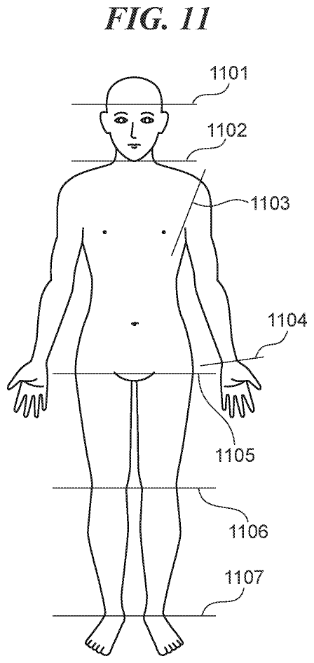

Hereinafter, an image pickup apparatus 100 according to the third embodiment will be described with reference to FIGS. 11 to 16B. The third embodiment is characterized in that it notifies the user that a photo that the user has taken or a photo that the user is about to take is a photo in which a joint of the avatar is cut off (a joint cut-off photo). It should be noted that in the third embodiment, descriptions of parts that overlap with the first embodiment will be omitted.

FIG. 11 is a diagram that shows an example of joints that should not be cut off when performing the portrait photographing. It is generally considered that a photo having a framing where one of joint portions, which are shown in FIG. 11 and mainly include a forehead 1101, a neck 1102, a shoulder 1103, a wrist 1104, a hip joint 1105, a knee 1106, and an ankle 1107, is cut off in the portrait photographing (the joint cut-off photo) should be avoided.

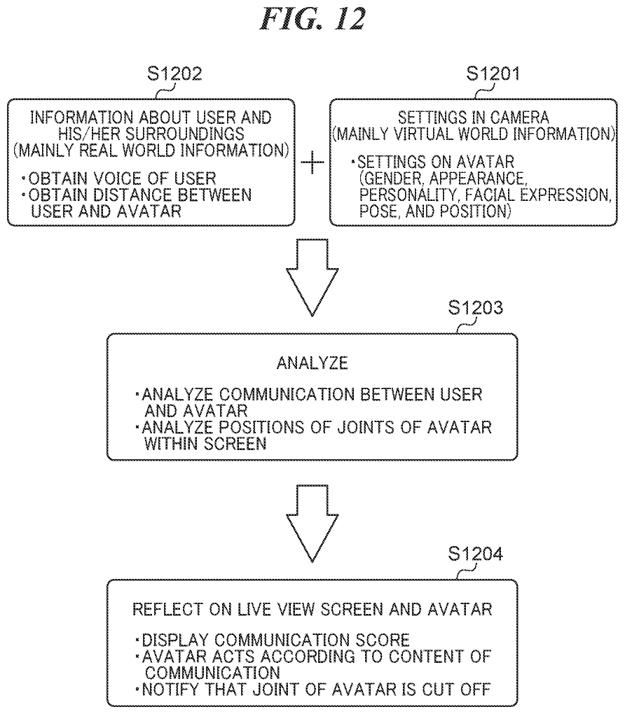

First, an analyzing processing according to the third embodiment executed by the image pickup apparatus 100 will be described with reference to FIG. 12.

As shown in FIG. 12, in a step S1203, the analyzing unit 122 analyzes where positions of the joints of the avatar are positioned within the live view screen. The method of this analysis will be described below.

Generally, an avatar is modeled by a processing that uses computer graphics (CG) technology to connect a plurality of points within a virtual three-dimensional space. In the third embodiment, the avatar control unit 123 performs the above processing. In addition, a point cloud (the plurality of points) used when modeling the avatar has coordinates within the virtual three-dimensional space. Therefore, the analyzing unit 122 obtains coordinate values of a predetermined portion of the avatar from the avatar control unit 123. Here, the predetermined portion refers to the position of the joint such as one of the forehead, the neck, the shoulder, the wrist, the hip joint, the knee, and the ankle that have been described above.

Next, the analyzing unit 122 (a coordinate associating unit) uses the distance sensor unit 113 to perform mapping of the real space around the user. Thereafter, the analyzing unit 122 associates the real space around the user and a photographing range during photographing performed by the image pickup apparatus 100 (the angle of view of the image pickup apparatus 100) with the coordinates within the virtual three-dimensional space, in which the avatar is modeled.

Thereafter, the analyzing unit 122 compares the coordinates of the predetermined portion of the avatar with coordinates of the inner boundary and the outer boundary of the angle of view of the image pickup apparatus 100. As a result, where the positions of the joints of the avatar are positioned within the live view screen is analyzed. In addition, based on this analysis result, the analyzing unit 122 is able to detect whether or not “it has become a framing where the predetermined portion of the avatar is cut off”.

In a step S1204, in the case that the analyzing unit 122 has detected that “it has become a framing where the predetermined portion of the avatar is cut off”, the detection result is displayed on the live view screen by using the display control unit 124. This display may be performed at a timing when the user has pressed a shutter.

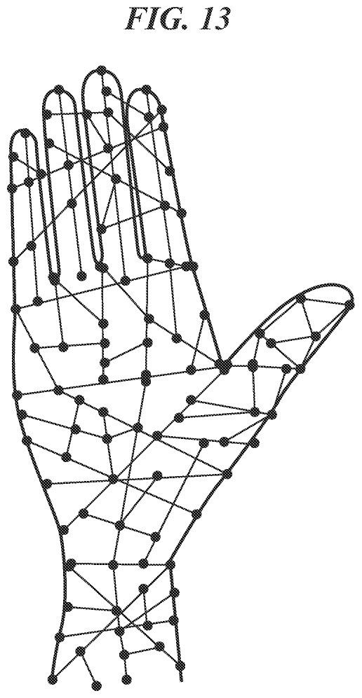

FIG. 13 is a diagram that shows an example of three-dimensional modeling of an avatar's wrist using a point cloud in CG. Each point in FIG. 13 has coordinates within the virtual three-dimensional space, and by controlling these coordinates, the avatar control unit 123 knows which portion of the avatar is in which position, not just the wrist. As a result, the avatar control unit 123 is able to operate (control) the behavior (the pose and the position) of the avatar.

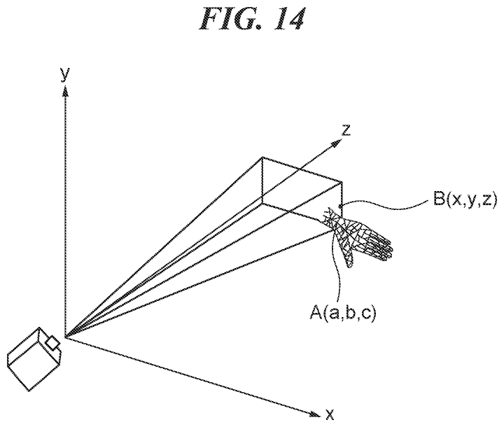

FIG. 14 is a conceptual diagram that shows a position of the avatar's wrist shown in FIG. 13 in the virtual three-dimensional space and the photographing range during photographing performed by the image pickup apparatus 100 associated with the virtual three-dimensional space.

The inner region represented by a quadrangular pyramid shown in FIG. 14 indicates the photographing range (the angle of view) of the image pickup apparatus 100. It should be noted that although a quadrangular pyramid is used for convenience, the photographing region in the depth direction is not limited to the bottom surface of the quadrangular pyramid, but includes the region up to infinity. That is, the four side surfaces of the quadrangular pyramid are the inner boundary and the outer boundary of the angle of view of the image pickup apparatus 100.

In the third embodiment, the analyzing unit 122 performs a processing to determine whether or not any one of the coordinates on the four side surfaces of the quadrangular pyramid shown in FIG. 14 match the predetermined portion of the avatar (a joint cut-off determining processing) during the processing of the steps S305 to S307 shown in FIG. 3. In the case that the user is about to press the shutter in a state where any one of the coordinates on the four side surfaces of the quadrangular pyramid shown in FIG. 14 match the predetermined portion of the avatar, or in the case that the user has pressed the shutter in the state where any one of the coordinates on the four side surfaces of the quadrangular pyramid shown in FIG. 14 match the predetermined portion of the avatar, the processing unit 120 notifies the user.

Hereinafter, for the purposes of describing the joint cut-off determining processing, the coordinates of a point A forming the joint of the avatar's wrist shown in FIG. 14 are assumed to be (a, b, c), and the coordinates of a point B on the surface forming the right-end boundary of the photographing range of the image pickup apparatus 100 shown in FIG. 14 are assumed to be (x, y, z).

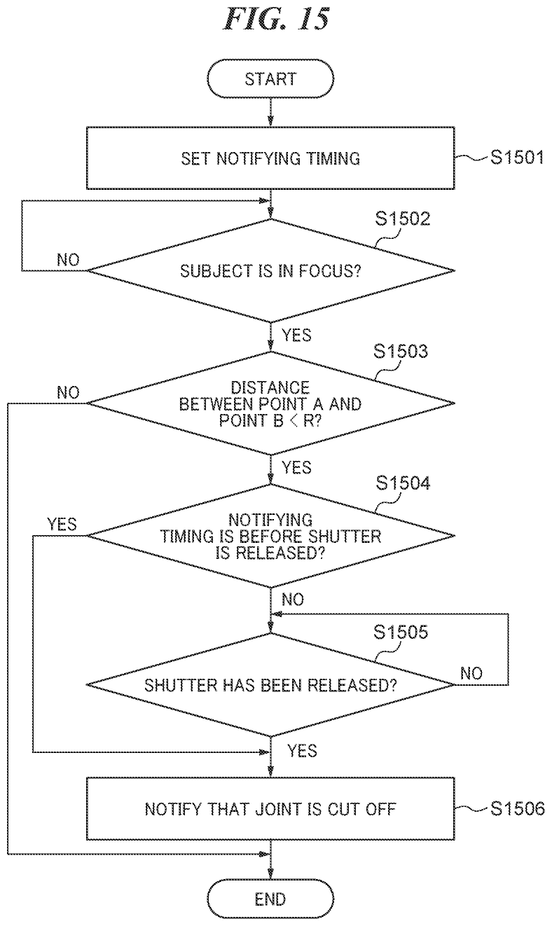

Next, the joint cut-off determining processing according to the third embodiment will be described with reference to a flowchart of FIG. 15.

As shown in FIG. 15, first, in response to a user operation on the operation unit 130, the setting unit 114 sets a timing for notifying that the joint is cut off (a step S1501). Here, as the timing for notifying that the joint is cut off (hereinafter, simply referred to as “a notifying timing”), the user is able to select either before the shutter is released or after the shutter has been released.

Next, the analyzing unit 122 determines whether or not the avatar, which is the subject, is in focus (a step S1502). Determining whether or not a subject is in focus is a basic function, and is widely installed in general cameras, so the description thereof will be omitted. In the case that the subject (the avatar) is in focus (YES in the step S1502), the joint cut-off determining processing shifts to a step S1503. It should be noted that in the third embodiment, the analyzing unit 122 determines that “the user is about to release the shutter” based on the state where “the subject is in focus”, but the present invention is not limited to this. For example, when there has been a half-pressing operation of a release button (not shown) of the image pickup apparatus 100 performed by the user, the analyzing unit 122 may determine that “the user is about to release the shutter”, and even if the subject (the avatar) is not in focus, the joint cut-off determining processing may shift to the step S1503.

Next, the analyzing unit 122 determines whether or not a distance between the point A forming the joint of the avatar's wrist and the point B on the surface forming the right-end boundary of the photographing range of the image pickup apparatus 100 is smaller than (shorter than) a predetermined distance R (the step S1503). Here, the coordinates of the point A are (a, b, c) and the coordinates of the point B are (x, y, z), so the distance between the point A and the point B is expressed by the following expression (1).

$$\begin{matrix}[ EXPRESSION ( 1 ) ] & \\ \sqrt{{( x - a )}^{2} + {( y - b )}^{2} + {( x - c )}^{2}} & ( 1 )\end{matrix}$$

In the case that the distance between the point A and the point B is smaller than the predetermined distance R (YES in the step S1503), the analyzing unit 122 detects that the joint cut-off has occurred, and the joint cut-off determining processing shifts to a step S1504. In this example, the analyzing unit 122 determines that the avatar's wrist is cut off at the right edge of the live view screen. On the other hand, in the case that the distance between the point A and the point B is equal to or greater than the predetermined distance R (NO in the step S1503), the analyzing unit 122 detects that no joint cut-off has occurred and ends the joint cut-off determining processing, and the photographing is continued.

Next, the analyzing unit 122 determines whether or not the notifying timing set in the step S1501 is before the shutter is released (the step S1504). In the case that the notifying timing set in the step S1501 is before the shutter is released (YES in the step S1504), the joint cut-off determining processing shifts to a step S1506, and the analyzing unit 122 notifies the user that the joint is cut off, and ends the joint cut-off determining processing. On the other hand, in the case that the notifying timing set in the step S1501 is after the shutter has been released (NO in the step S1504), no notification is given at this time, and the joint cut-off determining processing shifts to a step S1505.

Next, the analyzing unit 122 determines whether or not the shutter has been released by a full-pressing operation of the release button (not shown) of the image pickup apparatus 100 performed by the user (the step S1505). In the case that the shutter has been released (YES in the step S1505), the joint cut-off determining processing shifts to the step S1506, and the analyzing unit 122 notifies the user that the joint is cut off, and ends the joint cut-off determining processing.

Here, the processing of comparing the distance between the point A forming the joint of the avatar's wrist and the point B on the surface forming the right-end boundary of the photographing range of the image pickup apparatus 100 with the predetermined distance R has been described as an example, but the present invention is not limited to this. That is, the point A is applied to all of the joint portions of the avatar that have been described above with reference to FIG. 11. In addition, the point B is applied to all of the boundaries of the photographing range of the image pickup apparatus 100. By doing so, the analyzing unit 122 is able to detect “whether or not it has become a framing where the predetermined portion of the avatar is cut off”. It should be noted that joint portions of a model who is a subject in the real world need to be detected by using deep learning or the like, and the processing load required for detection is large. On the other hand, in the third embodiment, all coordinate information of the joint portions of the avatar that have been described above with reference to FIG. 11 is retained in advance in the image pickup apparatus 100, and the detection processing of the joint portions is not required. Therefore, without imposing a large processing load on the image pickup apparatus 100, the user is able to practice framing that does not cause the joint cut-off in the portrait photographing.

Although the method for detecting the joint cut-off by comparing the coordinates in the three-dimensional space (three-dimensional coordinates) has been described above, it is also possible to detect the joint cut-off by comparing two-dimensional coordinates after the three-dimensional space is projected onto a plane. In the CG technology, in order to render a three-dimensional model on a two-dimensional plane such as a display, a three-dimensional to two-dimensional conversion is performed, and this processing is referred to as projection. Projection methods include a parallel projection method and a perspective projection method, and since these projection methods are publicly known, descriptions thereof will be omitted. The coordinates of the joints that have been converted from the three-dimensional coordinates to the two-dimensional coordinates by using one projection method of these projection methods may be compared with the coordinates of the boundaries of the photographing range that have been converted from the three-dimensional coordinates to the two-dimensional coordinates by using one projection method of these projection methods. As a result, it is possible to reduce the load of the joint cut-off determining processing.

It should be noted that the joints of the avatar that are detected by the image pickup apparatus 100 according to the third embodiment are not limited to the above example, and the user may add or remove any of the joints of the avatar as appropriate.

### <Screen Display>

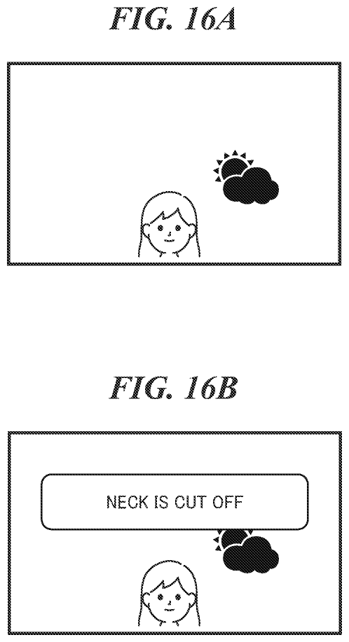

Next, the live view screens before and after a joint cut-off notification (a notification indicating that the joint is cut off) in the step S1506 shown in FIG. 15 is displayed will be described with reference to FIG. 16A and FIG. 16B.

As shown in FIG. 16A, in the case that the user has taken or is about to take a photo in which the joint of the avatar (here, the neck) is cut off, in the joint cut-off determining processing shown in FIG. 15, the analyzing unit 122 detects that the joint cut-off has occurred, and notifies the user that the joint is cut off. In the third embodiment, the display control unit 124 displays the joint cut-off notification on the display unit 143. For example, as shown in FIG. 16B, a message such as “the neck is cut off” is superimposed and displayed on the live view screen to notify the user of the joint cut-off notification, that is, to notify the user that it has become a framing where the joint is cut off.

In the case that the user is a beginner photographer, since there is a possibility to continue the photographing without noticing that the joint is cut off, it is also possible to reduce missed photographing (missed shots) by notifying the user of the joint cut-off notification.

It should be noted that as long as the user can be notified of the joint cut-off notification, the joint cut-off notification is not limited to the form of the message exemplified in FIG. 16B. For example, the joint cut-off notification may be given through communication by the avatar itself or the like. By giving the joint cut-off notification by using a method that the avatar itself points out the joint cut-off, or a method that the avatar itself has an angry look on its face, it can be also expected to have the effect of not compromising the user's sense of immersion when performing the photographing.

As described above, in the third embodiment, in the case that the user has taken the photo that the joint of the avatar is cut off, or in the case that the user is about to take the photo that the joint of the avatar is cut off, the user is notified of this. This allows the user to develop a feel for avoiding the framing in which the joint of the subject is cut off. Furthermore, as a result, it is possible to reduce missed shots when photographing real people.

### (Fourth Embodiment) (Quality Evaluation Value of Photographed Image)

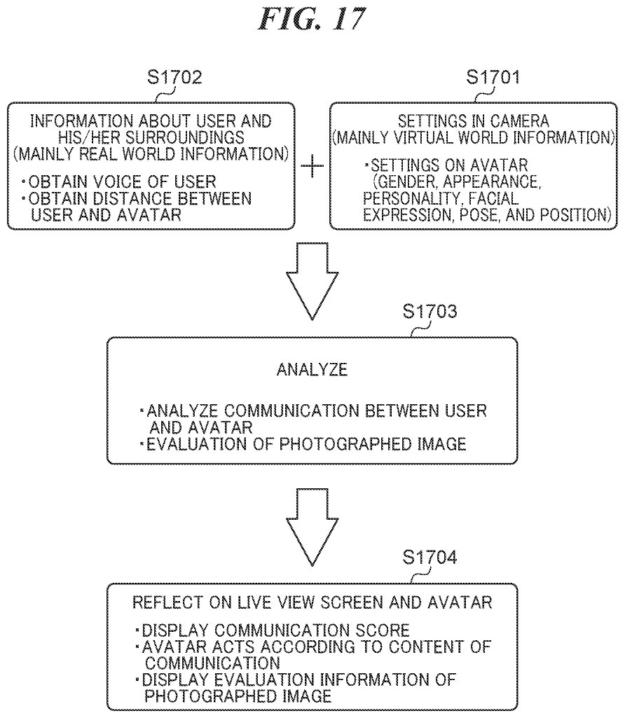

Hereinafter, an image pickup apparatus 100 according to the fourth embodiment will be described with reference to FIGS. 17 to 20. The fourth embodiment is characterized in that evaluation information of an image photographed by the image pickup apparatus 100 is generated and is provided to the user. It should be noted that in the fourth embodiment, descriptions of parts that overlap with the first embodiment will be omitted.

In the fourth embodiment, the analysis of the image photographed by the image pickup apparatus 100 is performed, and the evaluation information is generated based on the result of the analysis and is provided to the user. By referring to the evaluation information, the user is able to provide feedback to improve his/her own portrait photographing, thereby improving his/her photographing knowledge and skills.

First, an analyzing processing according to the fourth embodiment executed by the image pickup apparatus 100 will be described with reference to FIG. 17.

As shown in FIG. 17, in a step S1703, the analyzing unit 122 (a quality evaluation generating unit) performs the analysis of the photographed image and generates the evaluation information. The photographed image is a portrait image photographed by the image pickup apparatus 100 through communication with the avatar, in which the avatar is superimposed and displayed on a real object, and is an image that is recorded in the recording unit 141 when the operation to end the photographing is performed in the step S307. The user is able to select, via the operation unit 130, whether or not to generate the evaluation information with respect to any photographed image that has been recorded in the recording unit 141.

In a step S1704, the evaluation information generated in the step S1703 is displayed on the live view screen of the display unit 143 via the display control unit 124. As a result, the evaluation information is provided to the user.

Here, items to be analyzed for the photographed image include, for example, brightness, a contrast, a color saturation, a hue, sharpness, a composition, the amount of blurring, and a noise of the photographed image, as well as the facial expression, the pose, and the position of the avatar in the photographed image. Based on the analysis of these items, for example, a score, a graph, or the like for the entire photographed image or for each item is generated as the evaluation information.

As the method for calculating the score of the photographed image, for example, a calculation method using AI can be used.

An AI model used in this calculation method is trained, for example, as follows.

First, a portrait photo taken by a professional photographer is obtained, and various parameters, which have been extracted from the obtained portrait photo, are obtained.

Next, by inputting the various obtained parameters, the AI model is trained so that an output value (the score of the photographed image) becomes 100 points. By conducting this type of learning (training) with portrait photos taken by a variety of professional photographers, it is possible to create the AI model that the portrait photo taken by the professional photographer is set to 100 points.

It should be noted that for the items that are difficult to quantify, such as the composition, the facial expression, and the pose, an unspecified number of people can be asked to give each photo a score, and the AI model may be trained so that the average score of the scores given by the unspecified number of people becomes the output value (the score of the photographed image).

Furthermore, in the case that the AI model is trained so as to input the photo itself and output the average score of the scores given by the unspecified number of people, it will be possible to create the AI model that outputs individual scores for the facial expression, the pose, the composition, etc., respectively. In this case, each element of the facial expression, the pose, and the composition is scored by AI, and the output value becomes the input when calculating the evaluation value of the photographed image.

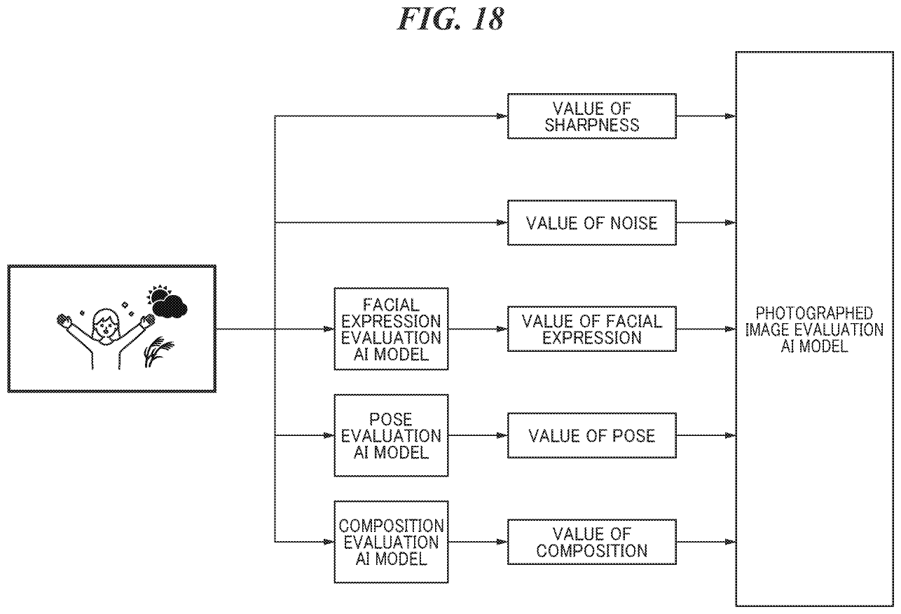

FIG. 18 is a diagram that shows an example of a relationship between an AI model that performs evaluation of the photographed image and its input parameters in the fourth embodiment. As shown in FIG. 18, the parameters that are easy to quantify, such as the sharpness and the noise, are extracted directly from the photographed image, and these values are used as input for a photographed image evaluation AI model. On the other hand, for the parameters that are difficult to quantify, such as the composition, the facial expression, and the pose, the photo is inputted into each of the AI models mentioned above, and the output value from each of the AI models is used as the input for the photographed image evaluation AI model. It should be noted that there are various methods for quantifying the sharpness, the noise, and the like, and since these methods are publicly known, descriptions thereof will be omitted.

In addition, labeling may simply be performed. For example, by assigning a numerical value to the facial expression, such as 1 for a smiling face and 2 for a sad face, and using these numerical values as input, it is also possible to train the AI model with trends in portrait photos taken by professional photographers.

It is possible to further enhance the accuracy by also training the AI model with portrait photos taken by photographers other than the professional photographers. The AI model may be additionally trained so that for example, when various parameters of a portrait photo taken by an amateur photographer are inputted, the output value (the score of the photographed image) will be 70 points. Similarly, for portrait photographing performed by a person who has never performed photographing with a camera other than a smartphone, the AI model may be additionally trained so that the output value (the score of the photographed image) becomes 30 points. Furthermore, a portrait photo that has win a prize in a contest or the like may be set to a high output value (a high score of the photographed image) to additionally train the AI model.

As a result, it is possible to create the AI model that has been trained so that the higher the quality of the portrait photo, the higher the output value. This AI model is created in advance and is loaded into (installed in) the analyzing unit 122. As a result, the analyzing unit 122 is able to generate the evaluation information of the photographed image, which has been taken by the user with the image pickup apparatus 100, by using the AI model.

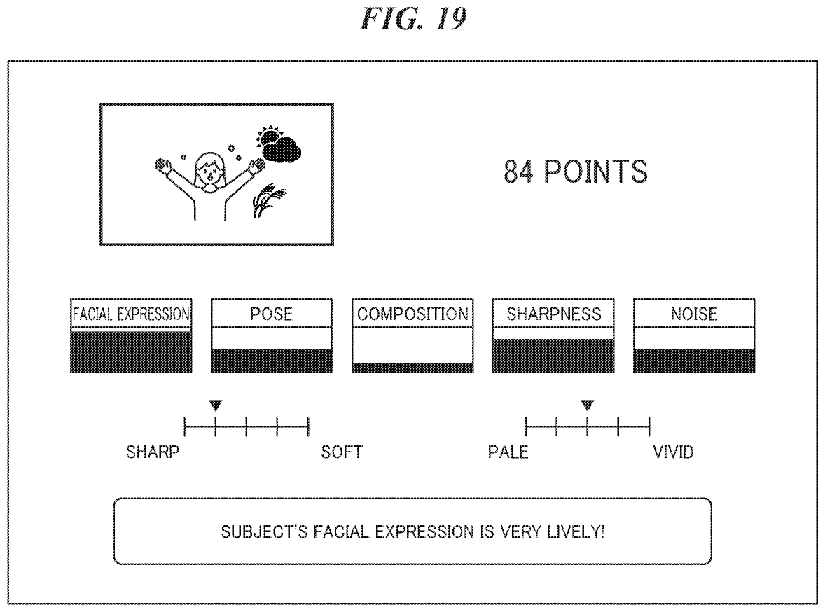

FIG. 19 is a diagram that shows an example of the evaluation information of the photographed image according to the fourth embodiment, which is generated by the analyzing unit 122 and is displayed on the display unit 143. The evaluation information shown in FIG. 19 is displayed on the display unit 143 of the image pickup apparatus 100. As shown in FIG. 19, the evaluation information includes the selected photographed image, an overall score, values and graphs of the respective items used in the analysis, an overall comment, etc.

In the example shown in FIG. 19, it can be seen that the value of “the composition” has been low. This allows the user to recognize points that he/she should review when performing photographing, such as “is the composition monotonous?” or “is the composition making the subject stand out?”.

In addition, although the items such as “the contrast” and “the color saturation” have been mentioned as the parameters when calculating the evaluation value of the photographed image, just because the values of these items are high does not necessarily mean that the photo is good, and they are merely indicators of photographic expression. Therefore, it may be possible to display such values in a way that indicates their classification.

For example, in FIG. 19, it is displayed that when the contrast is high, it will be classified as “sharp”, and when the contrast is low, it will be classified as “soft”. Similarly, it is displayed that when the color saturation is high, it will be classified as “vivid”, and when the color saturation is low, it will be classified as “pale”.

Furthermore, the overall comment based on the overall analysis may be generated and displayed. In the example shown in FIG. 19, since the value of “the facial expression” has been high, a comment “the facial expression of the subject is very lively!” is displayed. This allows the user to learn about his/her strengths in the portrait photographing, for example, “I am good at bringing out the facial expression of my subject”.

Here, as an example, because the value of “the facial expression” is high, the comment “the facial expression of the subject is very lively!” is displayed, but just because “the facial expression is not lively” does not necessarily mean that the value of “the facial expression” will become low. Specifically, even in the case that the facial expression is not lively, in the portrait, an expression method using an ennui-like expression can also be considered. Therefore, the values of “the facial expression” and other items are also calculated after being multifacetedly judged, respectively.

In the example shown in FIG. 19, the overall comment is a positive comment, but the overall comment is not limited to a positive comment and may be, for example, an advice or the like to the user. Specifically, the overall comment may be a comment such as “by performing photographing after getting a little closer to the subject so as to make the subject stand out”. This allows the user to also learn about his/her weaknesses, such as “the photo taken by the user himself/herself does not have a clear theme”.

Although the generation of the evaluation information with respect to one photographed image has been described above, information that integrates (combines) the generated evaluation information may be generated. Specifically, in the third embodiment, the analyzing unit 122 does not end after generating the evaluation information with respect to one photographed image, and may generate evaluation information with respect to a plurality of photographed images (a plurality of pieces of evaluation information), and generate information that integrates (combines) the plurality of pieces of evaluation information (hereinafter, referred to as “comprehensive information”). This allows the user to confirm a trend in the photographed images taken by the user himself/herself.

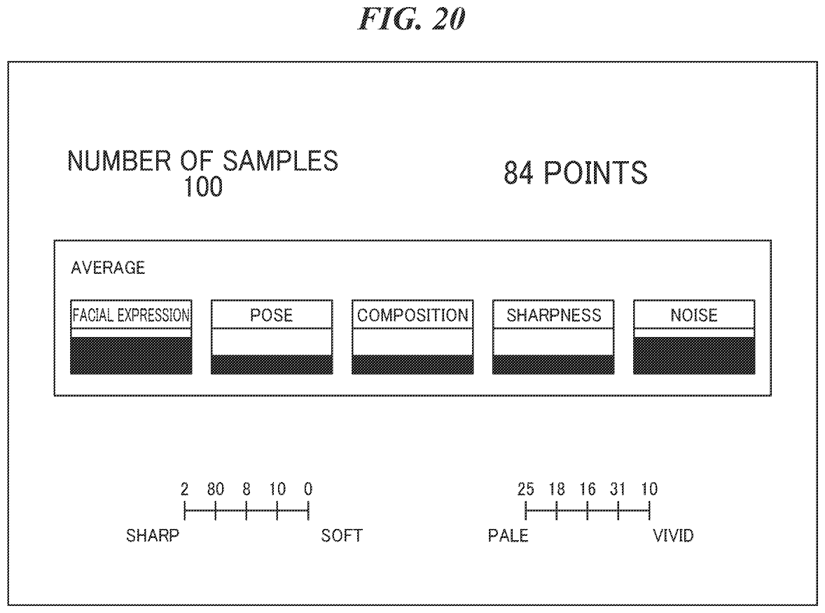

FIG. 20 is a diagram that shows an example of the comprehensive information of the plurality of photographed images according to the fourth embodiment, which is generated by the analyzing unit 122 and is displayed on the display unit 143. “The number of samples” is the number of images (photographed images) that have been used to generate the comprehensive information, and with respect to which, the evaluation information has been generated.

The values of the respective items, such as “the facial expression” and “the pose”, are displayed as the average values among the samples as the comprehensive information. By knowing the average values of the respective items, the user is able to more accurately understand his/her own strengths and weaknesses.

In addition, the evaluation information shown in FIG. 19 has displayed the degree of “sharpness”, the degree of “softness”, the degree of “paleness”, and the degree of “vividness” of the photographed image, but the evaluation information shown in FIG. 20 has displayed breakdowns of the degree of “sharpness”, the degree of “softness”, the degree of “paleness”, and the degree of “vividness” among the samples (the sample photographed images). Specifically, out of 100 samples (100 sample photographed images), there are 2 “sharp” samples, 80 “slightly sharp” samples, 8 “medium” samples, 10 “slightly soft” samples, and 0 “soft” sample. This allows the user to understand the trend, such as “I tend to take sharp portraits”. In addition, in view of the above trend, the overall comment such as “let's try a soft portrait” may be displayed. As a result, it is possible to perform the user support to broaden the scope of expression in the portrait photographing.

It should be noted that the items to be analyzed of the photographed image in the fourth embodiment are not limited to the elements listed above, and may be appropriately added in the case that there are elements that should be considered in evaluating the portrait photographing.

As described above, according to the fourth embodiment, since the user is able to confirm the evaluation information and the comprehensive information of the images taken by the user himself/herself, the user is able to understand the strengths, the weaknesses, and the trend in the portrait photographing performed by the user himself/herself. Furthermore, by feeding information on these back into the photographing performed by the user himself/herself, the user becomes able to improve his/her knowledge and skills in photographing and broaden the scope of his/her expression.

Although the preferred embodiments of the present invention have been described above, the present invention is not limited to these embodiments, and various forms that do not depart from the gist of the present invention are also included in the present invention. Furthermore, each of the above-described embodiments merely shows one embodiment of the present invention, and each embodiment can be appropriately combined.

For example, by combining the second embodiment and the fourth embodiment, it is possible to perform the analysis and evaluation of the photographed image, including the lighting with respect to the subject (the avatar). Specifically, as shown in the live view screens of FIG. 9B and FIG. 10B, in the case that the lighting is not good and only the subject's face is dark, this may result in a decrease in the overall score.

In addition, as the comprehensive information, breakdowns of the number of the samples with “front lighting”, the number of the samples with “side lighting”, and the number of the samples with “back lighting” among the samples (the sample photographed images) may be displayed. For example, in the case that the proportion of the samples with “back lighting” is very small, the user is able to broaden the scope of his/her expression in photographing by, for example, “trying taking more portraits with back lighting”.

In each of the embodiments described above, the case where “a person” has been applied as an avatar has been described as an example, but the present invention is not limited to this example, and an animal may be applied as an avatar. For example, since dogs and cats are in high demand as pets, by applying a dog or a cat as an avatar, it is also possible to use the present invention to practice photographing a pet.

In addition, in each embodiment of the present invention, when viewed from other people, it appears as if the photographer is calling out to the model (the avatar) in various ways, even though the model is not in front of the image pickup apparatus 100. For this reason, it is generally assumed that the image pickup apparatus 100 will be used in a space such as the photographer's own room or a studio where the photographer does not need to worry about being seen by other people. However, in order to allow practice in the portrait photographing or the pet photographing even in a place where other people's eyes are concerned, the photographer may be allowed to perform a processing equivalent to silent calling out with respect to the image pickup apparatus 100. In this case, the photographer may be able to register the text of the content of the calling out in advance, or the predetermined content of the calling out may be preset in the image pickup apparatus 100. As a result, in the case of using the image pickup apparatus 100 in a place where other people's eyes are concerned, the photographer is able to perform the processing equivalent to silent calling out by selecting the content of the calling out, which has been text-registered (or has been preset) and is displayed on the touch panel type display of the operation unit 130.

Furthermore, in addition to a photographing mode (a first photographing mode) in which the avatar is superimposed and displayed on the live view screen as described in the first embodiment, the second embodiment, the third embodiment, and the fourth embodiment, the image pickup apparatus 100 may also have a normal photographing mode (a second photographing mode) in which the avatar is not superimposed and displayed on the live view screen.

It should be noted that, in the embodiments of the present invention, it is also possible to implement processing in which a program for implementing one or more functions is supplied to a computer of a system or an apparatus via a network or a storage medium, and a system control unit of the system or the apparatus reads out and executes the program. The system control unit may include one or more processors or circuits, and in order to read out and execute executable instructions, the system control unit may include multiple isolated system control units or a network of multiple isolated processors or circuits.

The processor or circuit may include a central processing unit (CPU), a micro processing unit (MPU), a graphics processing unit (GPU), an application-specific integrated circuit (ASIC), and/or a field-programmable gate array (FPGA). In addition, the processor or circuit may include a digital signal processor (DSP), a data flow processor (DFP), or a neural processing unit (NPU).

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., ASIC) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-123327, filed on Jul. 28, 2023, which is hereby incorporated by reference herein in its entirety.

What is claimed is:

1. An image pickup apparatus including a display unit that superimposes and displays an image of a virtual three-dimensional avatar on a live view screen, the image pickup apparatus comprising:
an obtaining unit configured to obtain first elements including information about a user and his/her surroundings;
a setting unit configured to, in response to a user operation, set second elements including elements of the three-dimensional avatar, which change in response to communication with the user, and elements of the three-dimensional avatar, which do not change in response to the communication;
at least one processor; and
a memory coupled to the processor storing instructions that, when executed by the processor, cause the processor to function as:
an analyzing unit that performs analysis based on the first elements obtained by the obtaining unit and the second elements set by the setting unit; and
a control unit that performs control so as to reflect a result of the analysis on the live view screen and the image of the three-dimensional avatar that is superimposed and displayed on the live view screen.

2. The image pickup apparatus according to claim 1, wherein
the obtaining unit obtains a voice of the user as the first element.

3. The image pickup apparatus according to claim 1, wherein
the obtaining unit obtains a distance between the user and the three-dimensional avatar as the first element.

4. The image pickup apparatus according to claim 1, wherein
the obtaining unit obtains at least one of a type, an amount of light, a color, a position of a light source of ambient light around the user, and the number of the light sources as the first elements.

5. The image pickup apparatus according to claim 1, wherein
the setting unit, in response to a user operation, further sets at least one of a type, an amount of light, a color, a position of a light source of virtual light that performs virtual lighting with respect to the three-dimensional avatar, and the number of the light sources.

6. The image pickup apparatus according to claim 1, wherein
the elements of the three-dimensional avatar, which do not change in response to the communication, include at least one of an age, a gender, an appearance, and a personality of the three-dimensional avatar, and
the elements of the three-dimensional avatar, which change in response to the communication, include at least one of a facial expression, a pose, and a position of the three-dimensional avatar.

7. The image pickup apparatus according to claim 2, further comprising:
a sound output unit configured to output a spoken voice of the three-dimensional avatar, and
wherein the control unit performs control so as to reflect information based on the analyzing unit in the spoken voice of the three-dimensional avatar outputted from the sound output unit.

8. The image pickup apparatus according to claim 7, wherein
the analyzing unit, based on the first elements and the second elements, performs analysis of at least one or more of
what and how much the user speaks to the three-dimensional avatar;
a frequency of silence of the user, a volume of the voice of the user, and a speed at which the user speaks;
the number of times speaking of the user overlaps with speaking of the three-dimensional avatar in a conversation; and
a ratio of a speaking time of the user to a speaking time of the three-dimensional avatar.

9. The image pickup apparatus according to claim 1, wherein
the analyzing unit analyzes a quality of the communication between the user and the three-dimensional avatar based on the first elements and the second elements, and generates an analysis result that has been quantified.

10. The image pickup apparatus according to claim 9, wherein
the analyzing unit changes the analysis result depending on the elements of the three-dimensional avatar, which change in response to the communication, the first elements, and the analysis result.

11. The image pickup apparatus according to claim 1, wherein
the instructions, when executed by the processor, cause the processor to further function as a coordinate associating unit that associates an angle of view of the image pickup apparatus with coordinates within a virtual three-dimensional space, in which the three-dimensional avatar is modeled, and
the analyzing unit, based on a position of a joint of the three-dimensional avatar in the virtual three-dimensional space, and the angle of view of the image pickup apparatus associated with the coordinates within the virtual three-dimensional space by the coordinate associating unit, analyzes whether or not a photo that the user has taken or a photo that the user is about to take is a photo in which the joint of the three-dimensional avatar is cut off.

12. The image pickup apparatus according to claim 1, wherein
the instructions, when executed by the processor, cause the processor to further function as a quality evaluation generating unit that generates a quality evaluation with respect to a photographed image photographed by the image pickup apparatus, in which the three-dimensional avatar is superimposed and displayed on a real object, and
the quality evaluation is generated by analyzing at least one of brightness, a contrast, a color saturation, a hue, sharpness, a composition, the amount of blurring, and a noise of the photographed image, and at least one of a facial expression, a pose, and a position of an avatar in the photographed image.

13. The image pickup apparatus according to claim 12, wherein
the quality evaluation generating unit generates the quality evaluation with respect to a plurality of photographed images photographed by the image pickup apparatus, and generates comprehensive information that integrates all the generated evaluation information.

14. The image pickup apparatus according to claim 1, wherein
the control unit performs a blurring processing with respect to the three-dimensional avatar that is superimposed and displayed on the live view screen according to a depth of field and an in-focus distance that have been determined by the image pickup apparatus.

15. The image pickup apparatus according to claim 4, wherein
the control unit reflects the at least one of the type, the amount of light, the color, the position of the light source of the ambient light, and the number of the light sources, which have been obtained by the obtaining unit, in lighting to the three-dimensional avatar that is superimposed and displayed on the live view screen.

16. The image pickup apparatus according to claim 5, wherein
the control unit reflects the at least one of the type, the amount of light, the color, the position of the light source of the virtual light, and the number of the light sources, which have been set in response to the user operation, in lighting to the three-dimensional avatar that is superimposed and displayed on the live view screen.

17. The image pickup apparatus according to claim 1, wherein
the image pickup apparatus includes a first photographing mode, in which the three-dimensional avatar is superimposed and displayed on the live view screen, and a second photographing mode, in which the three-dimensional avatar is not superimposed and displayed on the live view screen.

18. A control method for an image pickup apparatus including a display unit that superimposes and displays an image of a virtual three-dimensional avatar on a live view screen,
the control method comprising:
an obtaining step of obtaining first elements including information about a user and his/her surroundings;
a setting step of, in response to a user operation, setting second elements including elements of the three-dimensional avatar, which change in response to communication with the user, and elements of the three-dimensional avatar, which do not change in response to the communication;
an analyzing step of performing analysis based on the first elements obtained in the obtaining step and the second elements set in the setting step; and
a control step of performing control so as to reflect a result of the analysis on the live view screen and the image of the three-dimensional avatar that is superimposed and displayed on the live view screen.

19. A non-transitory computer-readable storage medium storing a program for causing a computer to execute a control method for an image pickup apparatus including a display unit that superimposes and displays an image of a virtual three-dimensional avatar on a live view screen,
the control method comprising:
an obtaining step of obtaining first elements including information about a user and his/her surroundings;
a setting step of, in response to a user operation, setting second elements including elements of the three-dimensional avatar, which change in response to communication with the user, and elements of the three-dimensional avatar, which do not change in response to the communication;
an analyzing step of performing analysis based on the first elements obtained in the obtaining step and the second elements set in the setting step; and
a control step of performing control so as to reflect a result of the analysis on the live view screen and the image of the three-dimensional avatar that is superimposed and displayed on the live view screen.
